(19) United States
(12) Patent Application Publication
(10) Pub. No.: US 2026/0064115 A1
(43) Pub. Date: Mar. 5, 2026

(54) Network Architecture for a Mobility Foundation Model

(71) Applicant: Vayu Robotics, Inc., Palo Alto, CA (US)

(72) Inventors: Soumith Udatha, San Francisco, CA (US); Peter Jans Gillespie, Redwood City, CA (US); Arul Gupta, Palo Alto, CA (US); Nitish Srivastava, Cupertino, CA (US)

(73) Assignee: Vayu Robotics, Inc., Palo Alto, CA (US)

(21) Appl. No.: 19/319,448

(22) Filed: Sep. 4, 2025

Related U.S. Application Data
(60) Provisional application No. 63/690,732, filed on Sep. 4, 2024.
(60) Provisional application No. 63/714,607, filed on Oct. 31, 2024.

(51) Int. Cl. G05D 1/229; B60W 60/00; G05B 13/02; G05D 101/15

(52) U.S. Cl. CPC G05D 1/229; B60W 60/001; G05B 13/027; G05D 2101/15

(57) ABSTRACT

Systems and methods for implementing mobility foundation models in accordance with some embodiments of the invention are illustrated. One embodiment includes a method for operating a mobile device. The method receives initial state tokens, wherein each corresponds to data reflecting a previous state of a mobile device. The method determines a sub-task for the mobile device by applying an LLM to the initial state tokens. The method encodes sensor data into patch tokens. Each of the patch tokens reflects a recent state of the mobile device. The method updates the initial state tokens into updated state tokens, based on the patch tokens and the sub-task. The method produces navigation waypoints from the updated state tokens, wherein each of the navigation waypoints represents a distinct destination for the mobile device. The method controlling the mobile device according to the navigation waypoints.

### CROSS-REFERENCE TO RELATED APPLICATIONS

The current application claims the benefit of and priority under 35 U.S.C. § 119(e) to U.S. Provisional Patent Application No. 63/690,732, entitled “Network Architecture for a Mobility Foundation Model,” filed Sep. 4, 2024, and U.S. Provisional Patent Application No. 63/714,607, entitled “Network Architecture for a Mobility Foundation Model,” filed Oct. 31, 2024. The disclosures of U.S. Provisional Patent Application Nos. 63/690,732 and 63/714,607 are hereby incorporated by reference in their entireties for all purposes.

### FIELD OF THE INVENTION

The present invention generally relates to navigation systems and, more specifically, neural network architectures applied to autonomous robotics.

### BACKGROUND

Autonomous vehicles are vehicles that can be operated independently, utilizing sensors such as cameras to update knowledge of their environment in real-time, and enabling navigation with minimal additional input from users. Autonomous vehicles can be applied to various areas related to the transportation of people and/or items, including retail, e-commerce, supply, and/or delivery. In many cases, autonomous vehicle algorithms commonly use Artificial Intelligence (AI), and primarily machine learning (ML), models, for core functions.

Transformers refer to a machine learning architecture that effectively processes sequential data, such as text or audio, by learning the relationships and context between different parts of a given sequence. In doing so, subsets of the sequential data may be converted to numerical representations called tokens. Using a component know as an attention mechanism, transformers are able to generate dynamic representations of the relationships between the subsets based on the context between them. Specifically, attention mechanisms are able to weigh the importance of different input tokens (e.g., words) during processing. Transformers and attention mechanisms are especially effective when applied to circumstances where new data is continuously coming in, such as navigation.

### SUMMARY OF THE INVENTION

Systems and methods for implementing mobility foundation models in accordance with some embodiments of the invention are illustrated. One embodiment includes a method for operating a mobile device. The method receives, at the mobile device, an initial plurality of state tokens, wherein each of the initial plurality of state tokens corresponds to transformer model data reflecting at least one previous state of a mobile device. The method further receives sensor data, in part from a set of one or more sensors that are appended to the mobile device. The method determines at least one sub-task for the mobile device by inputting the sensor data into at least one vision transformer. The method encodes the sensor data, using at least one vision transformer, into a plurality of patch tokens. Each of the plurality of patch tokens reflects at least one recent state of the mobile device. The at least one recent state corresponds to a period before the at least one previous state. The method updates the initial plurality of state tokens into an updated plurality of state tokens, by inputting the initial plurality of state tokens into at least one cross-attention transformer wherein: each of the updated plurality of state tokens corresponds to transformer model data reflecting the at least one recent state of the mobile device; and the initial plurality of state tokens are updated based on the plurality of patch tokens and the at least one sub-task. The method produces a set of navigation waypoints from the updated plurality of state tokens, wherein each of the set of navigation waypoints represents a distinct destination for the mobile device. The method controls the mobile device according to the set of navigation waypoints.

In a further embodiment, the mobile device is an autonomous vehicle.

In another embodiment, the set of one or more sensors includes at least one camera.

In another embodiment, encoding the sensor data into the plurality of patch tokens further comprises adding learned ray embeddings, produced using at least one Multi-Layer Perceptron (MLP), into each of the plurality of patch tokens.

In another embodiment, producing the set of navigation waypoints comprises producing, using a primary query decoder and the updated plurality of state tokens, at least one proposed path for the mobile device.

In a further embodiment, the primary query decoder comprises at least one Diffusion Policy Decoder.

In another further embodiment, the method decodes a natural language query into a decoded query using a secondary query decoder, wherein the natural language query is received through a user interface.

In a further embodiment, the method projects an answer to the decoded query on the user interface, wherein the answer to the decoded query is based on the updated plurality of state tokens and the sensor data.

In another further embodiment, the secondary query decoder: comprises an additional large language model; and operates more slowly than the primary query decoder.

In yet another further embodiment, the particular large language model, the at least one vision transformer, the at least one cross-attention transformer, the primary query decoder, and the secondary query decoder are components of a foundation model.

In another further embodiment, the at least one proposed path is produced using a specific cross-attention transformer included in the primary query decoder, according to keys and values derived from the updated plurality of state tokens.

In still another further embodiment, the primary decoder operates on the mobile device; and the secondary decoder operates on a remote server that is communicatively coupled to the mobile device.

In another further embodiment, a given path of the at least one proposed path is selected from the group consisting of: a planned spatial path comprising a set of spatially-separated points with consistent spacing; a planned temporal path comprising a set of temporally-separated points with consistent spacing, derived according to a linear speed of the mobile device; and a left boundary and a right boundary for the mobile device.

In yet another further embodiment, the plurality of patch tokens comprises encodings of at least one of: an estimate of a kinematic state of the mobile device, wherein the estimate comprises a linear speed of the mobile device and an angular speed of the mobile device; a set of dimensions for the mobile device; or a set of route instructions that are pre-determined for the mobile device.

In another embodiment, updating the initial plurality of state tokens comprises inputting the plurality of patch tokens and the at least one sub-task into a state aggregator.

In a further embodiment, updating the initial plurality of state tokens further comprises: producing a set of queries from the initial plurality of state tokens; generating answers to the set of queries, using a cross-attention transformer included in the state aggregator, according to keys and values derived from the plurality of patch tokens and the at least one sub-task; and applying the answers to updating the initial plurality of state tokens.

In a further embodiment, updating the initial plurality of state tokens further comprises inputting the updated plurality of state tokens into at least one of a feed-forward network or a self-attention network.

In a still further embodiment, the at least one of the feed-forward network or the self-attention network is incorporated into the state aggregator.

In another embodiment, a quantity of the initial plurality of state tokens remains constant when updated into the updated plurality of state tokens.

One embodiment includes a non-transitory computer-readable medium including instructions that, when executed, are configured to cause a processor to perform a process for operating a mobile device. The process receives, at the mobile device, an initial plurality of state tokens, wherein each of the initial plurality of state tokens corresponds to transformer model data reflecting at least one previous state of a mobile device. The process further receives sensor data, in part from a set of one or more sensors that are appended to the mobile device. The process determines at least one sub-task for the mobile device by inputting the sensor data into at least one vision transformer. The process encodes the sensor data, using at least one vision transformer, into a plurality of patch tokens. Each of the plurality of patch tokens reflects at least one recent state of the mobile device. The at least one recent state corresponds to a period before the at least one previous state. The process updates the initial plurality of state tokens into an updated plurality of state tokens, by inputting the initial plurality of state tokens into at least one cross-attention transformer wherein: each of the updated plurality of state tokens corresponds to transformer model data reflecting the at least one recent state of the mobile device; and the initial plurality of state tokens are updated based on the plurality of patch tokens and the at least one sub-task. The process produces a set of navigation waypoints from the updated plurality of state tokens, wherein each of the set of navigation waypoints represents a distinct destination for the mobile device. The process controls the mobile device according to the set of navigation waypoints.

In a further embodiment, the mobile device is an autonomous vehicle.

In another embodiment, the set of one or more sensors includes at least one camera.

In another embodiment, encoding the sensor data into the plurality of patch tokens further comprises adding learned ray embeddings, produced using at least one Multi-Layer Perceptron (MLP), into each of the plurality of patch tokens.

In another embodiment, producing the set of navigation waypoints comprises producing, using a primary query decoder and the updated plurality of state tokens, at least one proposed path for the mobile device.

In a further embodiment, the primary query decoder comprises at least one Diffusion Policy Decoder.

In another further embodiment, the process decodes a natural language query into a decoded query using a secondary query decoder, wherein the natural language query is received through a user interface.

In a further embodiment, the process projects an answer to the decoded query on the user interface, wherein the answer to the decoded query is based on the updated plurality of state tokens and the sensor data.

In another further embodiment, the secondary query decoder: comprises an additional large language model; and operates more slowly than the primary query decoder.

In yet another further embodiment, the particular large language model, the at least one vision transformer, the at least one cross-attention transformer, the primary query decoder, and the secondary query decoder are components of a foundation model.

In another further embodiment, the at least one proposed path is produced using a specific cross-attention transformer included in the primary query decoder, according to keys and values derived from the updated plurality of state tokens.

In still another further embodiment, the primary decoder operates on the mobile device; and the secondary decoder operates on a remote server that is communicatively coupled to the mobile device.

In another further embodiment, a given path of the at least one proposed path is selected from the group consisting of: a planned spatial path comprising a set of spatially-separated points with consistent spacing; a planned temporal path comprising a set of temporally-separated points with consistent spacing, derived according to a linear speed of the mobile device; and a left boundary and a right boundary for the mobile device.

In yet another further embodiment, the plurality of patch tokens comprises encodings of at least one of: an estimate of a kinematic state of the mobile device, wherein the estimate comprises a linear speed of the mobile device and an angular speed of the mobile device; a set of dimensions for the mobile device; or a set of route instructions that are pre-determined for the mobile device.

In another embodiment, updating the initial plurality of state tokens comprises inputting the plurality of patch tokens and the at least one sub-task into a state aggregator.

In a further embodiment, updating the initial plurality of state tokens further comprises: producing a set of queries from the initial plurality of state tokens; generating answers to the set of queries, using a cross-attention transformer included in the state aggregator, according to keys and values derived from the plurality of patch tokens and the at least one sub-task; and applying the answers to updating the initial plurality of state tokens.

In a further embodiment, updating the initial plurality of state tokens further comprises inputting the updated plurality of state tokens into at least one of a feed-forward network or a self-attention network.

In a still further embodiment, the at least one of the feed-forward network or the self-attention network is incorporated into the state aggregator.

In another embodiment, a quantity of the initial plurality of state tokens remains constant when updated into the updated plurality of state tokens.

One embodiment includes a method for operating a mobile device. The method. The method receives, at a mobile device, an initial plurality of state tokens, wherein each of the initial plurality of state tokens corresponds to transformer model data reflecting at least one previous state of a mobile device. The method further receives sensor data, from a set of one or more sensors that are appended to the mobile device. The method determines at least one sub-task for the mobile device by inputting the initial plurality of state tokens into a particular large language model. The method encodes the sensor data into a plurality of patch tokens, by inputting the sensor data into at least one vision transformer. Each of the plurality of patch tokens reflects at least one recent state of the mobile device. The at least one recent state corresponds to a period before the at least one previous state. The method updates the initial plurality of state tokens into an updated plurality of state tokens by inputting the initial plurality of state tokens into at least one cross-attention transformer. Each of the updated plurality of state tokens corresponds to transformer model data reflecting the at least one recent state of the mobile device. A quantity of the initial plurality of state tokens remains constant when updated into the updated plurality of state tokens. The initial plurality of state tokens are updated based on the plurality of patch tokens and the at least one sub-task. The method produces, by the mobile device, a set of navigation waypoints from the updated plurality of state tokens. Producing the set of navigation waypoints comprises producing at least one proposed path for the mobile device, wherein the at least one proposed path is produced using a specific cross-attention transformer included in a primary query decoder, according to keys and values derived from the updated plurality of state tokens. Each of the set of navigation waypoints represents a distinct destination for the mobile device. The method controls the mobile device according to the set of navigation waypoints. When a natural language query, corresponding to the mobile device, is received through a user interface of the mobile device the method decodes the natural language query into a decoded query using a secondary query decoder, wherein the secondary query decoder: comprises an additional large language model; and operates more slowly than the primary query decoder. The particular large language model, the at least one vision transformer, the at least one cross-attention transformer, the primary query decoder, and the secondary query decoder are components of a foundation model. The method further projects an answer to the decoded query on the user interface, wherein the answer to the decoded query is based on the updated plurality of state tokens and the sensor data.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which form a part of this disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The description will be more fully understood with reference to the following figures and data graphs, which are presented as exemplary embodiments of the invention and should not be construed as a complete recitation of the scope of the invention.

FIGS. 1A-1F illustrate mobility foundation model implementations applied in accordance with certain embodiments of the invention.

FIGS. 2A-2C illustrate images representing plans configured in accordance with various embodiments of the invention.

FIG. 3 illustrate an example of an autonomous vehicle operation system that monitors navigation of vehicles operating in accordance with some embodiments of the invention.

FIG. 4 illustrates an example of an autonomous robot configured to implement systems configured in accordance with some embodiments of the invention.

FIG. 5 conceptually illustrates an autonomous robot configured in accordance with many embodiments of the invention.

FIGS. 6A-6B illustrate an example of a camera configured in accordance with a number of embodiments of the invention.

### DETAILED DESCRIPTION

Turning now to the drawings, network architectures for implementing autonomous navigation systems configured in accordance with various embodiments of the invention are illustrated. Such network architectures may enhance the accuracy of navigation techniques for autonomous driving and/or autonomous robots including (but not limited to) wheeled robots, delivery systems, and/or autonomous vehicles. In this disclosure, autonomous robots may frequently be referred to as autonomous navigation systems and, as such, carry the capacity for self-driving through tele-ops. Potential autonomous vehicles that may be implemented in accordance with some embodiments, are cars, trucks, vans, ships, aeronautic vehicle, and aerial vehicles.

Neural network configurations implemented in accordance with many embodiments of the invention (the mobility foundation model) may be used to facilitate intelligent mobility for robot form factors across many domains. Neural network architectures implemented in some embodiments of the invention may utilize a variety of inputs from a variety of sensor systems, including but not limited to audio, video, images, and/or measurements (e.g., of acceleration, velocity, orientation, and/or position). This may effectively allow autonomous robots to be instructed, through natural language, to solve various mobility tasks across configurations. By incorporating a sense of state, represented through tokens (individual units of data) that are fed into mobility foundation models during training, models implemented in accordance with some embodiments of the invention may run with a significantly lower latency compared to standard transformer models that typically operate on a concatenation of historical frames.

As can readily be appreciated, the specific requirements of the neural network architecture of a given autonomous robot are largely dependent upon the requirements of a specific application. A variety of system configurations applicable (but not limited) to autonomous robots are discussed further below.

### A. Mobility Foundation Model Configurations

Transportation jobs are frequently carried out by different robot form factors using software that is domain and form factor specific. For example, self-driving car software may be configured to only drive cars on roads and not warehouses, and/or specifically on off-road settings. Making robots move safely and autonomously is crucial for many applications including last-mile delivery on public roads, material handling in warehouses and factories, infrastructure inspection, construction site monitoring, hospitality, and security. Nevertheless, issues like representing the occupancy and observability of 3D space, understanding spatial relationships and constraints, detecting obstacles, and anticipating behaviors of other moving agents are generally shared across domains and robots.

Systems and methods in accordance with various embodiments of the invention may utilize various neural network architectures to facilitate the transportation of autonomous robots in a broadly applicable manner, including but not limited to mobility foundation models. Foundation models may refer to a specific subset of AI models that are trained on broad quantities of datasets, frequently (though not uniformly) using self-supervision processes, allowing them to be adapted to wide ranges of (e.g., general purpose) potential applications. Mobility foundation models may refer to a subset of foundation models that are specifically trained on transportation/motion-based datasets, enabling to intuit complex mobility patterns. Mobility foundation models can configure transportation (e.g., autonomous) systems for diverse tasks a wide variety of potential applications, including but not limited to predicting system trajectory, optimizing routes, identifying position/orientation, and/or making real-time decision transportation systems.

Systems may incorporate (but are not limited to) transformer-based neural network architectures to drive autonomous robots. This navigation may be based on processing input including but not limited to: sequences of information coming from the autonomous robots' onboard sensors. In doing so, systems may produce outputs including but not limited to navigation waypoints.

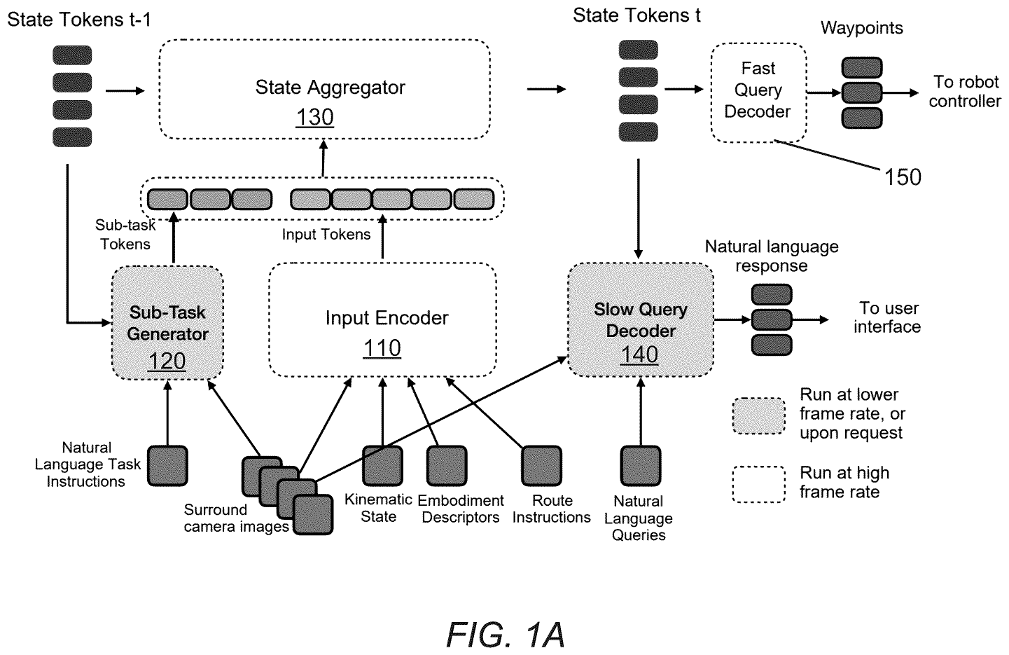

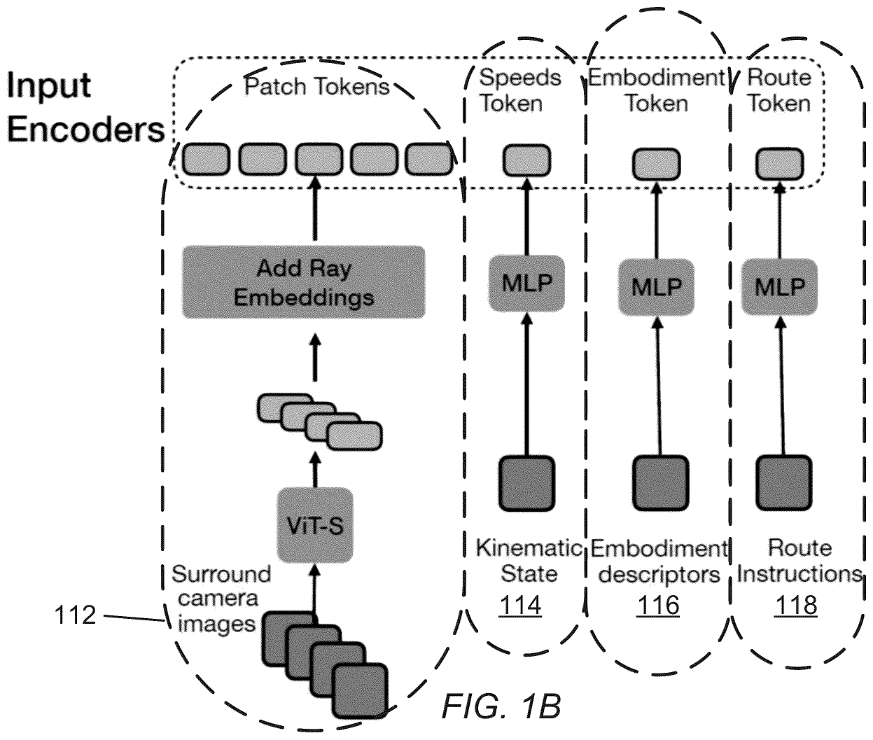

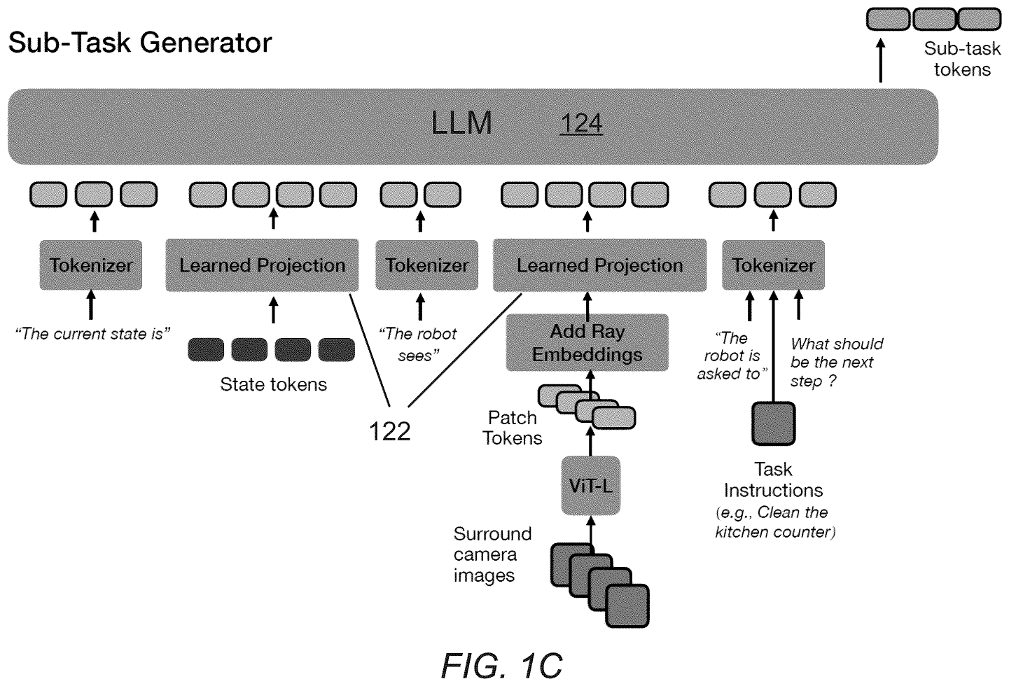

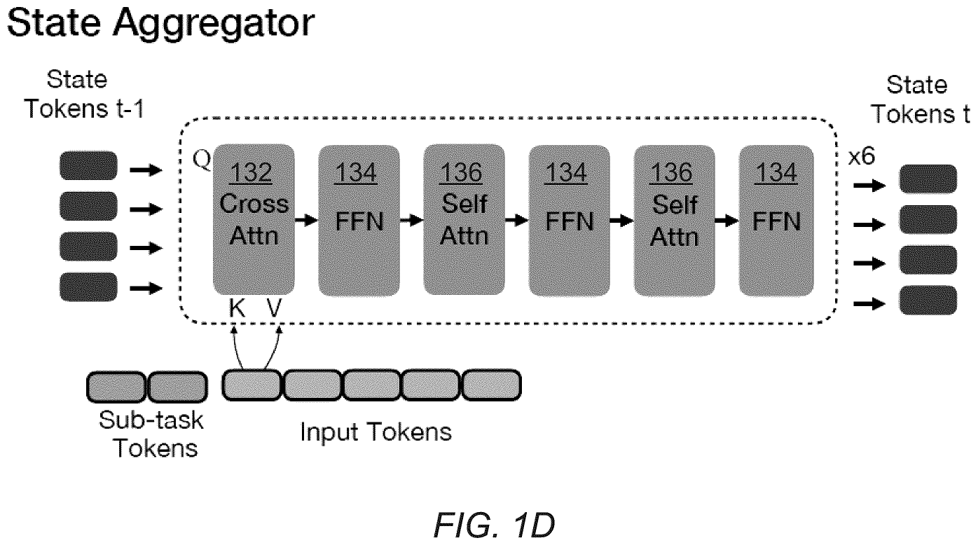

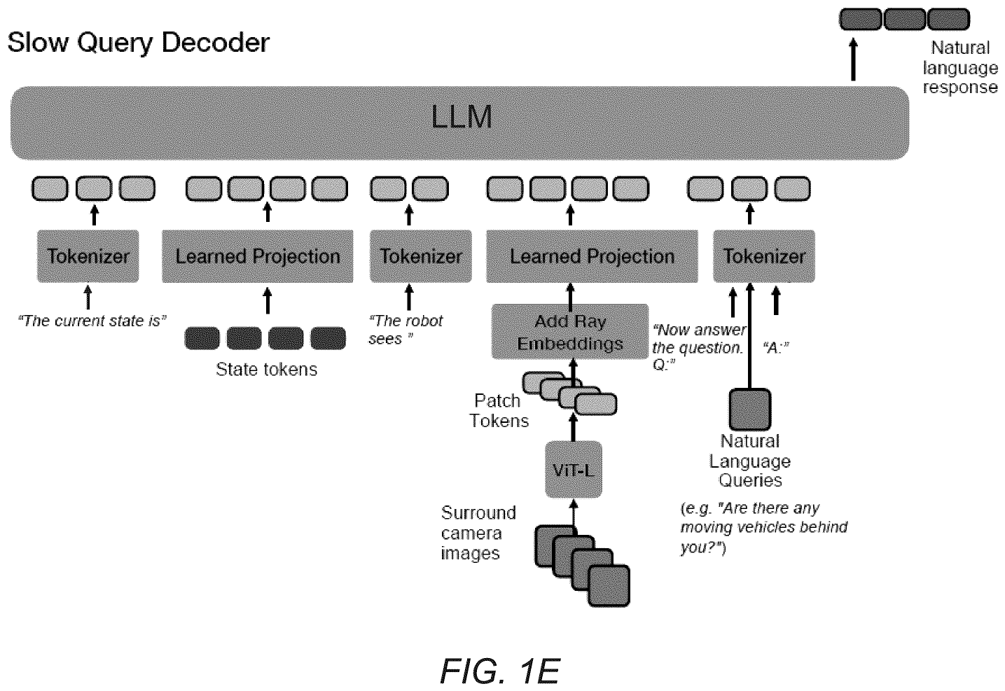

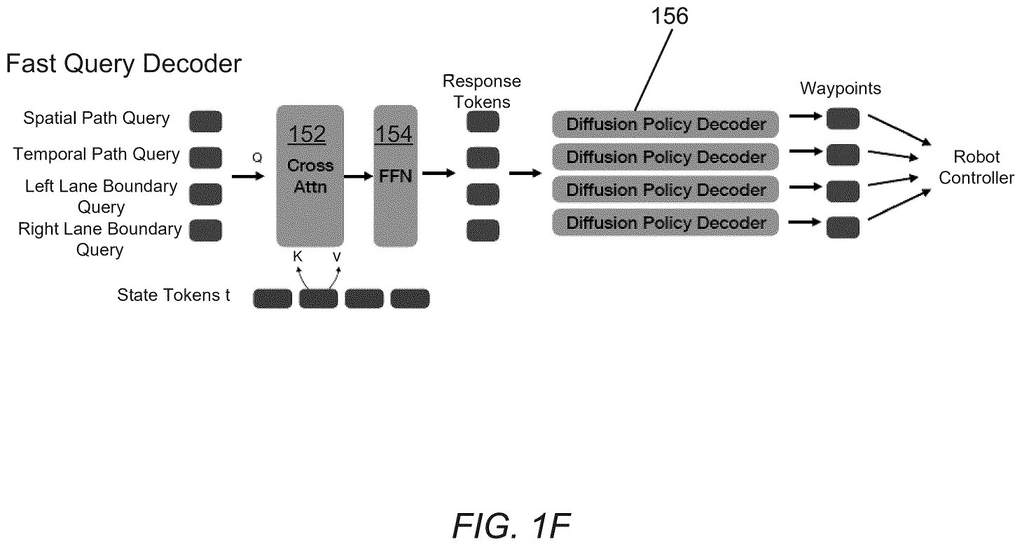

A mobility foundation model implemented in accordance with several embodiments of the invention is illustrated in FIGS. 1A-1F. The general neural network architecture outlined in FIG. 1A may incorporate components including but not limited to an input encoder 110, a sub-task generator 120, a state aggregator 130, a slow query decoder 140, and a fast query decoder 150. The salient capabilities of mobility foundation models implemented in accordance with several embodiments of the invention may include but are not limited to: factoring components of varying speeds, maintaining state (estimates), and/or changing sensor configurations.

As mentioned above, systems can communicate and work together to solve miscellaneous operative task(s) through fixed quantities of state tokens. In accordance with many embodiments of the invention, state tokens may correspond to numerical representations of state representations including but not limited to images and/or text (e.g., instructions, tasks). Several examples of token implementations are disclosed in Shang et al. (2022). StARformer: Transformer with State-Action-Reward Representations for Visual Reinforcement Learning. In Computer Vision—ECCV 2022. https://doi.org/10.1007/978-3-031-19842-7_27, the disclosure of which including the disclosure related to token implementations is incorporated herein by reference in its entirety. As can readily be appreciated, the specific token implementation is largely dependent upon the requirements of a given application. In many circumstances, transformer-based models can operate based on configurations including but not limited to: having a finite context size (L) (i.e., amount of text, represented as tokens, that the model can process) with a runtime of 0(L²); and/or having variable numbers of tokens (N) per time frame (T), where the runtime for the total number of tokens (N×T) is close to 0(N²T²). In order to solve this problem, systems implemented in accordance with many embodiments of the invention may use fixed sets of tokens. Systems, configured in accordance with some embodiments of the invention, may use attention mechanisms including but not limited to cross-attention with input tokens to reduce runtimes to 0(NM), where M is the number of state tokens.

In several embodiments of the invention, some aspects of autonomous navigation (for example, understanding instructions and breaking them into sub-tasks) may involve deeper processing and reasoning compared to more instinctive tasks (e.g., braking for a sudden path obstruction, lane keeping for an on-road robot). In order to have both types of processing (instinctual/fast and reasoned/slow) available and cooperating, systems implemented in accordance with multiple embodiments of the invention may separate mobility foundation models into separate (sub) systems including but not limited to fast on-robot systems and slow task generators 120.

In accordance with various embodiments, fast (e.g., on-robot) systems may be configured to implement processes that run at high frame rates (e.g., multiple times per second) including but not limited to encoding sensor (e.g., camera) inputs (input encoders 110), aggregating states (state aggregators 130), and/or producing the planned robot paths (fast query decoders 150). Using singular processors (e.g., a single Nvidia Jetson AGX Orin) the resulting frame rate may be greater than or equal to 10 frames per second. In many embodiments, the fast on-robot systems (e.g., the input encoder 110, the state aggregator 130, the fast query decoder 150) may be configured to run onboard the autonomous robots.

In accordance with several embodiments of the invention slow task generators may be configured to implement processes including but not limited to generating sub-tasks based on task instructions (sub-task generators 120) and/or responding to user inquiries (the slow query decoder 140). As mentioned, in accordance with multiple embodiments of the invention, the slow components can (additionally or alternatively) run on remote servers where more computer resources can be made available and/or be configured to run at lower frame rates (e.g., once every few seconds). The slow task generators (e.g., the sub-task generator 120, the slow query decoder 140) may be configured to run on remote servers. These remote servers may be implemented to communicate with autonomous robots implemented in accordance with certain embodiments of the invention through modes including but not limited to wireless connections (e.g., Wi-Fi and/or cellular data connections).

As illustrated in FIG. 1A, the distributed nature of this implementation may allow for each of the various components to perform distinct operations. Therefore, the states in the fixed set of state tokens may be maintained by the mobility foundation models and/or can be updated at each time step. This can completely remove dependence on time and make it possible to run the mobility foundation models at much more efficient frame rates.

The application of input encoders (e.g., 110) operating in accordance with various embodiments of the invention is illustrated in FIG. 1B. As suggested above, the mobility foundation models may operate based on a variety of inputs. Input encoders (including but not limited to sensor (e.g., camera) encoders 112, kinematic state encoders 114, embodiment encoders 116, and/or route encoders 118) may therefore be used to encode the incoming robot-directed data into (e.g., state) tokens. The tokens may, in various cases, be initialized to some learned values when the corresponding autonomous robots come online. Systems in accordance with several embodiments of the invention may be able to map inputs (of various types) to sets of tokens in shared embedding spaces.

Camera encoders 112 implemented in accordance with several embodiments of the invention may encode (“tokenize”) camera images into sets of patch tokens (“patches”) using transformers including but not limited to vision transformers (ViT). Implementations of patch tokens are disclosed in Dosovitskiy et al. (2020). An Image is Worth 16×16 Words: Transformers for Image Recognition at Scale. ArXiv. https://arxiv.org/abs/2010.11929, the disclosure of which, specifically the portions describing image patch tokenization, is incorporated by reference herein in its entirety. However, various different patch token-based configurations may be utilized in accordance with various embodiments of the invention, beyond those disclosed in the above reference. In many embodiments, the transformers may be initialized from the “small” Dinov2 checkpoint, an open-source vision model. The implementation of Dinov2 is disclosed in P. Bojanowski et al., “Dinov2: Learning robust visual features without supervision,” 2023, the disclosure of which (especially the portions directed to transformer initialization) is incorporated by reference herein in its entirety. Nevertheless, numerous varying vision models besides Dinov2 may be applied to systems operating in accordance with many embodiments of the invention. In some cases, the fixed number of state tokens may be increased, including but not limited to when the sensors incorporated into the corresponding autonomous robots have increased. As such, a certain number of tokens may correspond to each individual sensor, meaning that new autonomous robot sensors can contribute additional new input tokens for the mobility foundation models to use. Due to the use of ray embeddings, the positions of the sensors (including but not limited to the cameras) may be runtime configurable. As such, sensor (e.g., camera) inputs to the mobility foundation models (e.g., via the camera encoders 112) may include but are not limited to camera position and field-of-view. In many embodiments of the invention, cameras may be configured to produce 1920×1080 images at 10 frames per second; input encoders may be configured to down-sample these images to 392×224.

Mobility foundation models configured in accordance with various embodiments of the invention may use (e.g., patch) tokens for localization purposes. In order to identify and/or encode which part of the world (i.e., world model) certain patches come from, systems implemented in accordance with various embodiments of the invention may add learned ray embeddings into the individual patches. The ray embeddings may be computed using the intrinsics and extrinsics of the cameras and/or camera calibrations. The embeddings may be produced using neural networks including but not limited to feedforward neural networks such as Multi-Layer Perceptrons (MLPs). In many embodiments, the MLPs may take, as input, the origin and/or direction of the ray(s) corresponding to the center of given patches in the autonomous robots' coordinate systems. During training, systems operating in accordance with various embodiments may randomize the intrinsics, extrinsics, and/or number of cameras, which can make it possible for the mobility foundation models to transfer to new camera positions at test time.

Additionally or alternatively, other input encoders may be used to account for various other significant system inputs (by encoding state tokens). In accordance with many embodiments of the invention, the encoding performed by these other input encoders may be performed using neural networks including but not limited to MLPs. Kinematic state encoders 114 may be used to encode motion-based characteristics including but not limited to linear speed (in m/s) and/or angular speed (rad/s) into one or more tokens. In accordance with several embodiments of the invention, embodiment encoders 116 may encode embodiment descriptors that summarize characteristics of the autonomous robots including but not limited to size, physical shape, dimensions, presence of certain components (e.g., legs, wheels), and capabilities (e.g., whether it can climb stairs) into one or more tokens. In accordance with some embodiments of the invention, route encoders 118 may represent routes (to be followed by the autonomous robots) as sequences of discrete instructions (encoded as one or more tokens). In some cases, the above instructions may be basic (e.g., Straight, Left Turn, or Right Turn) and/or govern actions taken over brief periods/distances (e.g., each instruction corresponding to 2 m intervals over the next 40 m). Nevertheless, in some embodiments, all of the above encoders 112, 114, 116, 118 may be combined into a single encoder. Additionally or alternatively, the specific encoders (and encoder configurations) used may depend upon the requirements of the specific applications.

The configuration of sub-task generators (e.g., 120) operating in accordance with some embodiments of the invention is illustrated in FIG. 1C. Systems operating in accordance with many embodiments of the invention may use sub-task generators to determine sub-tasks that the autonomous robot can execute based on components including but not limited to natural language task instructions, (state) tokens, and/or sensor (e.g., image) inputs. In several embodiments, sub-tasks may be generated using large language models (LLMs 124) that are fine-tuned to follow instructions. Generation of these sub-tasks may follow methods similar to those disclosed in H. Liu et al., “Visual instruction tuning,” 2023, the disclosure of which (specifically the parts directed to the generation of multimodal language-image instruction-following data—e.g., through combining vision encoders and LLMs) is incorporated by reference herein in its entirety. In various embodiments of the invention, sub-tasks may describe operations that are more spatially grounded and/or prioritize spatial intelligence and/or common sense over abstract thinking. As such, in many embodiments, sub-tasks can be encoded as sets of embedding vectors and passed to the state aggregator(s) 130. In some cases, the embedding vectors may be configured to remain constant until the next sub-task is generated. Additionally or alternatively, learned projection functions 122 may be used to map the state tokens and/or the camera tokens to the embedding space of the LLM 124. In several embodiments, the learned projection functions 122 may be parametrized as neural networks including but not limited to feedforward neural networks such as MLPs.

The application of state aggregators (e.g., 130) operating in accordance with multiple embodiments of the invention is illustrated in FIG. 1D. The state aggregators may be used for maintaining (system) states using components including but not limited to the (fixed numbers of) state tokens.

In many cases, the state tokens may be updated using input tokens including but not limited to those described above. As mentioned above, in several embodiments of the invention, tokens including but not limited to state tokens may be initialized to learned values when the autonomous robot comes online. At each successive time step, the state (tokens) may be updated using transformers including but not limited to cross-attention transformers 132. Using a (e.g., cross-attention) transformer 132, the state tokens may produce queries, which can be answered using keys and values derived from the sub-task and input tokens. The transformers 132 may, in various cases, be used in tandem with (e.g., followed by, preceded by) feed-forward networks (FFN 134). In accordance with many embodiments of the invention, different classifications of transformers may be utilized combination with any of a variety of appropriate networks.

Systems in accordance with various embodiments of the invention may use state tokens to generate queries. For example, to develop new queries, the state tokens may then go through one or more self-attention 136 blocks. As shown in FIG. 1D, each of these instances of self-attention may be followed by an FFN 134. In the abstract, this process may effectively correspond to the mobility foundation models first seeing the new tokens to gather information (via cross-attention), then reconciling their internal states with gathered information to produce new queries (via self-attention). This entire sequence may be repeated multiple times, each time updating the state tokens. Running through the above process six times has been found especially effective for optimal performance.

Systems for decoding various types of queries in accordance with certain embodiments of the invention are illustrated in FIGS. 1E-1F. In many embodiments, slow query decoders may be configured to run in response to direct requests made to the autonomous robots (e.g., by users). Additionally or alternatively, fast query decoders may be configured to run automatically/in real-time in response to action-guiding queries.

The updated state (tokens) described in relation to FIG. 1D may, additionally or alternatively, be applied to answer natural language queries (e.g., from users). In many embodiments of the invention this may be accomplished using slow query decoders (e.g., 150). Slow query decoders can be invoked to answer queries including but not limited to questions about the driving behavior of and/or environments surrounding autonomous robots. This component may use systems (e.g., LLMs) similar to the sub-task generator described above; however, in (addition or) alternative to generating sub-tasks in reply to task instructions, slow query decoders may be configured to produce (natural language) responses in reply to particular (natural language) queries. The final responses may be represented as text and/or images that can be sent to one or more user interfaces for the querying user(s) to review.

Fast query decoders (e.g., 150) may be used to produce paths for autonomous robots to follow based on (but not limited to) the updated state (tokens). The fast query decoder may produce path plans by decoding states into various quantities of interest that are needed for driving. In particular, systems in accordance with certain embodiments of the invention may use various learned queries to decode paths including but not limited to: planned spatial paths, including XY coordinates (i.e., waypoints) estimated to be a specific distance away in 2D and/or 3D space (e.g., 1 m apart in 2D space); planned temporal paths, including XY coordinates estimated for specific time intervals (e.g., 100 millisecond time intervals); and left/right lane boundaries that are XY coordinates estimated to be a specific distance away in 2D and/or 3D space (e.g., 1 m apart in 2D space) and/or for specific time intervals (e.g., 100 millisecond time intervals). In doing so, systems in accordance with many embodiments may use cross-attention transformers 152 to produce queries that can be responded to using keys and values derived from the (e.g., updated state) tokens. As above, the cross-attention transformers 152 may be followed by feed-forward networks (FFNs 154). Additionally or alternatively, response tokens output by the FFNs 154 may be input into one or more diffusion policy decoders 156 during fine-tuning to facilitate precision in the autonomous robots. The final (path) output may be represented as waypoints that can be sent to controllers (for the autonomous robots) to execute. While specific path configurations are disclosed in this application, path outputs derived in accordance with many embodiments of the invention may take of a wide range of forms.

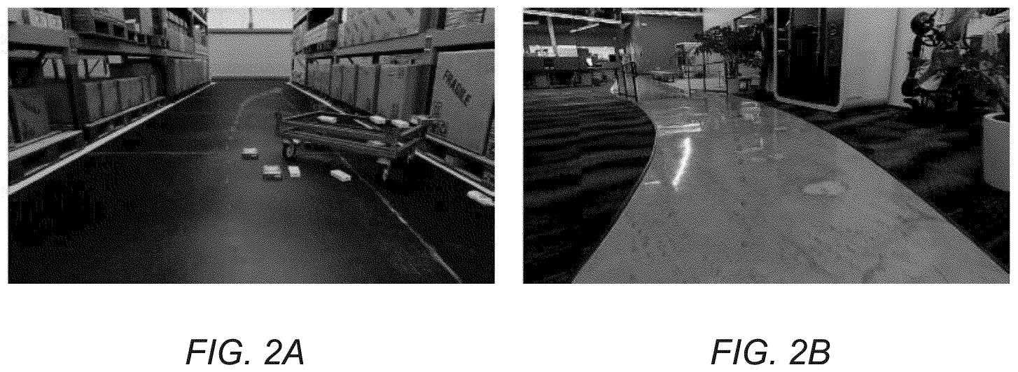

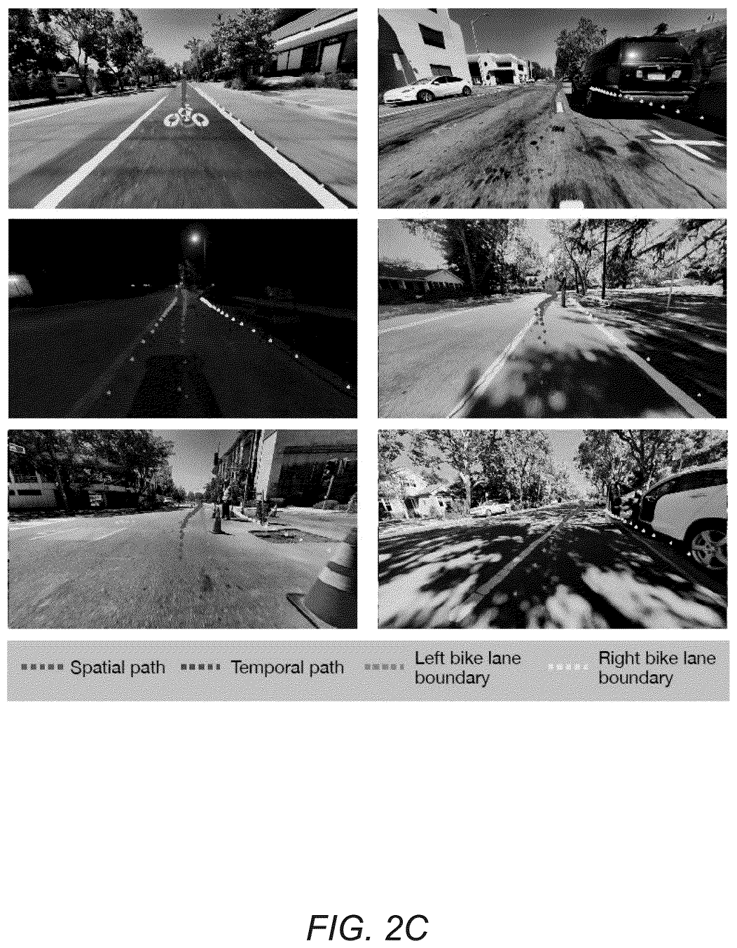

Visual representations of path outputs generated in accordance with miscellaneous embodiments of the invention are illustrated in FIGS. 2A-2C. Such path outputs may be generated by, but are not limited to (e.g., fast) query decoders. In many embodiments of the invention, (planned) path outputs may take forms including but not limited to spatial paths (e.g., based on robot position), temporal paths (e.g., based on robot position and/or velocity), and/or boundaries (e.g., to ensure the safety of the robot and/or compliance with the long-term instructions of the robot).

FIGS. 2A and 2B depict planned spatial paths generated in accordance with some embodiments of the invention: FIG. 2A depicts a first spatial path for a driving task occurring in a bike lane; FIG. 2B depicts a second spatial path for a driving task occurring in a simulated warehouse. As mentioned above, the planned spatial paths are configured using XY (and/or XYZ) coordinates generated such that the various waypoints are 1 m apart in 2D space. In various embodiments, the waypoints may be generated with roughly consistent distances according to the position and/or trajectory of the vehicle (as determined using state/state tokens). Additionally or alternatively, in many embodiments of the invention, the planned temporal paths may be configured using XY (and/or XYZ) coordinates generated as extrapolations of the vehicles estimated position after rough time durations. In many ideal implementations, the various waypoints of planned temporal paths may be determined at periods of 100 milliseconds. Additionally or alternatively, in many embodiments of the invention, boundary paths may be configured using XY (and/or XYZ) coordinates to ensure ongoing compliance with overarching concerns including but not limited to the safety of the vehicle and the general destination/route plans. As such, the boundary paths may be positioned as left and right lanes and/or (in some cases) as upper and lower boundaries.

FIG. 2C expands the visual representation to depict four decoded paths depicted as XY coordinates, wherein the spatial path is depicted in red, the temporal path is depicted in purple, a left lane boundary is depicted in green, and a right lane boundary is depicted in yellow. The examples depicted in FIG. 2C are all based around bike lane driving tasks. As such, the left and right lane boundaries are specifically configured to comply with the bike lane boundaries. Nevertheless, in accordance with several embodiments of the invention, vehicle thoroughfares including but not limited to paved streets, roads, sidewalks, water boundaries, hallways, and/or warehouse aisles may be bounded utilizing path outputs generated in accordance with several embodiments of the invention. Further, as depicted in FIG. 2C, paths may be decoded at various times of day and/or conditions.

While specific applications are described above for facilitating automated driving, any of a variety of processes can be utilized as appropriate to the requirements of specific applications in accordance with some embodiments of the invention. Furthermore, systems and methods in accordance with multiple embodiments of the invention are not limited to use within vehicular and/or navigational systems. Accordingly, it should be appreciated that the systems described herein can also be implemented outside the contexts described above with reference to FIGS. 1A-2C.

### B. Autonomous Vehicle Architecture

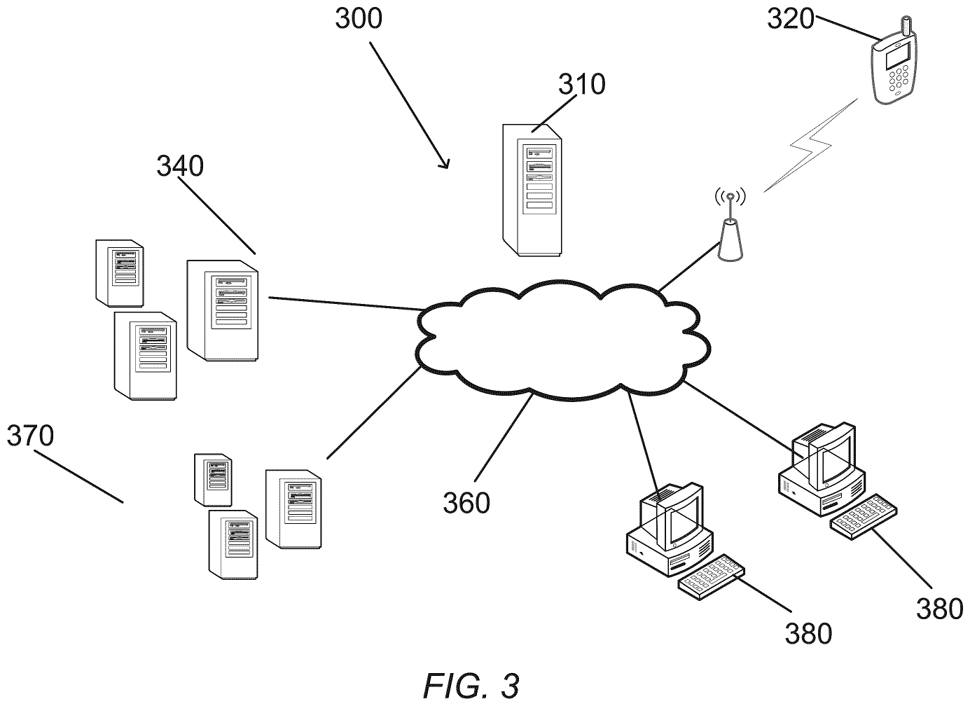

An example of an autonomous vehicle operation system that monitors navigation of vehicles operating in accordance with some embodiments of the invention is illustrated in FIG. 3. Autonomous vehicle operation systems 300 may include a communications network 360. The communications network 360 is a network such as the Internet that allows devices connected to the network 360 to communicate with other connected devices. Server systems 310, 340, and 370 are connected to the network 360. Each of the server systems 310, 340, and 370 is a group of one or more servers communicatively connected to one another via internal networks that execute processes that provide cloud services to users over the network 360. One skilled in the art will recognize that an autonomous vehicle operation system 300 may exclude certain components and/or include other components that are omitted for brevity without departing from this invention.

For purposes of this discussion, cloud services are one or more applications that are executed by one or more server systems to provide data and/or executable applications to devices over a network. The server systems 310, 340, and 370 are shown each having three servers in the internal network. However, the server systems 310, 340 and 370 may include any number of servers and any additional number of server systems may be connected to the network 360 to provide cloud services. In accordance with various embodiments of this invention, autonomous vehicle operation systems 300 that use sensors for state analysis in accordance with several embodiments of the invention may operate using processes executed on a single server system and/or a group of server systems communicating over network 360.

Users may use personal devices 380 and 320 that connect to the network 360 to perform processes that obtain sensory information in accordance with various embodiments of the invention. In the shown embodiment, the personal devices 380 are shown as desktop computers that are connected via a conventional “wired” connection to the network 360. However, the personal device 380 may be a desktop computer, a laptop computer, a smart television, an entertainment gaming console, or any other device that connects to the network 360 via a “wired” connection. The mobile device 320 connects to network 360 using a wireless connection. A wireless connection is a connection that uses Radio Frequency (RF) signals, Infrared signals, or any other form of wireless signaling to connect to the network 360. In the example of this figure, the mobile device 320 is a mobile telephone. However, mobile device 320 may be a mobile phone, Personal Digital Assistant (PDA), a tablet, a smartphone, or any other type of device that connects to network 360 via wireless connection without departing from this invention.

As can readily be appreciated the specific computing system used to operate an autonomous vehicle is largely dependent upon the requirements of a given application and should not be considered limited to any specific computing system(s) implementation.

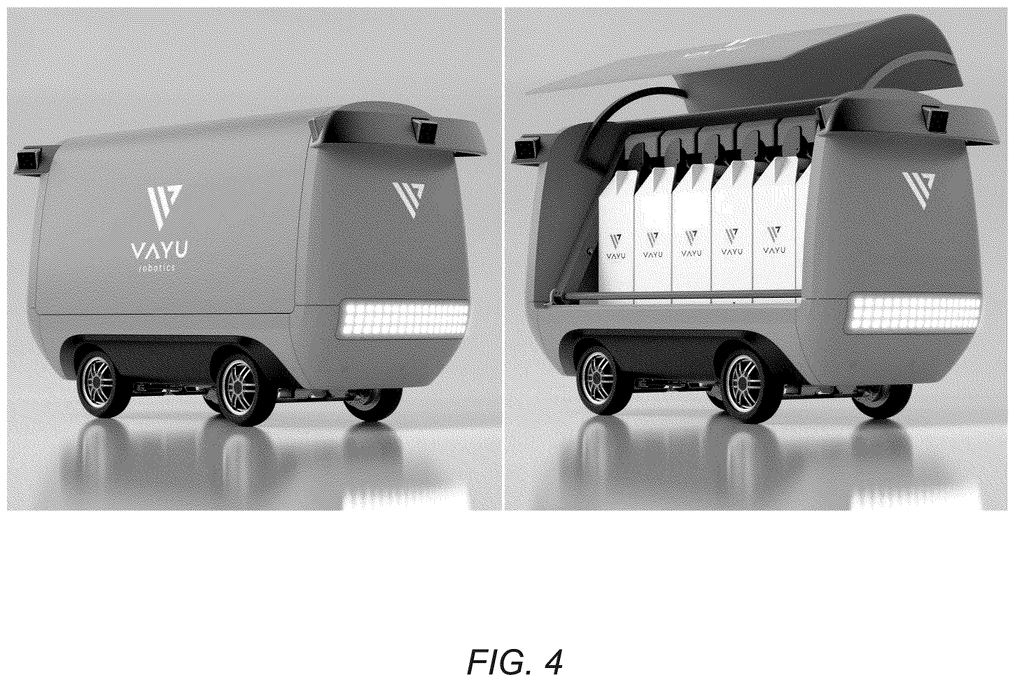

An autonomous (mobile) robot, operating in accordance with various embodiments of the invention, is illustrated in FIG. 4. In accordance with some embodiments, autonomous mobile robots may be configured to drive on settings including but not limited to public streets, highways, bike lanes, off-road areas, and/or sidewalks. In accordance with several embodiments of the invention, autonomous robots can utilize systems and methods similar to those described in U.S. patent application Ser. No. 18/416,820, entitled “Systems and Methods for Performing Autonomous Navigation,” filed Jan. 18, 2024, the disclosure of which, including the portions related to the implementation of autonomous robots and autonomous vehicles, is hereby incorporated by reference herein in its entirety. As mentioned above, the driving of autonomous mobile robots may be facilitated by models trained using machine learning techniques and/or teleoperation in real time. In accordance with many embodiments, system operations may be encoded as coordinates within two-dimensional (R²) reference frames. In some such reference frames, navigation waypoints represent destinations that autonomous robots are configured to reach. In some embodiments, these destinations may be encoded as XY coordinates in the reference frame (R²) and/or XYZ coordinates in the reference frame (R³).

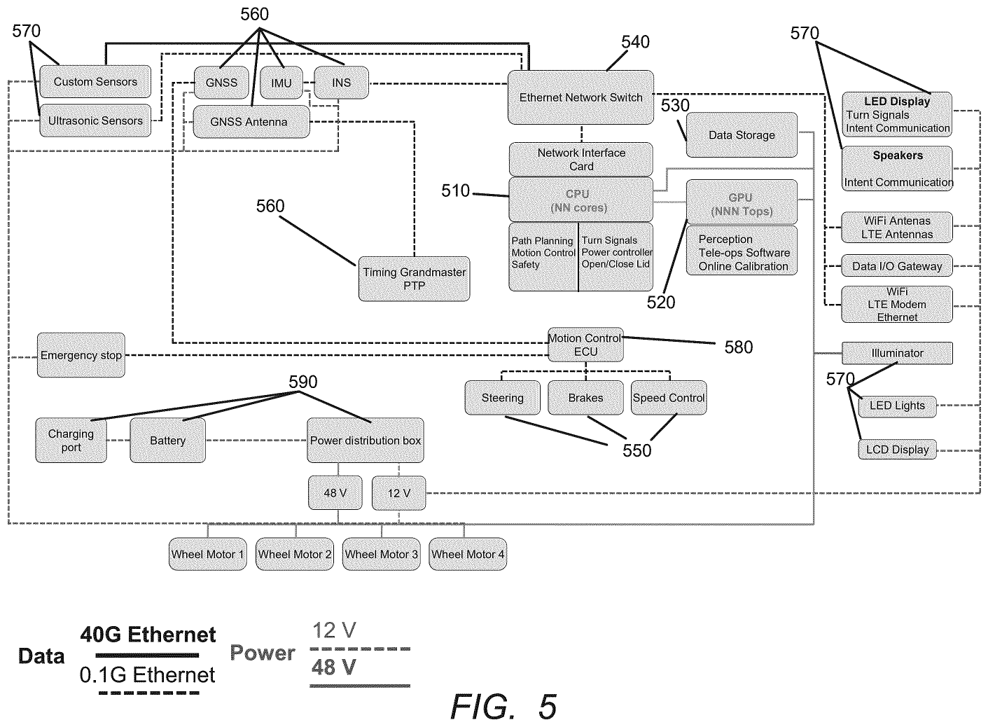

A conceptual diagram of an autonomous robot implementing systems operating in accordance with some embodiments of the invention is illustrated in FIG. 5. Autonomous robot implementations may include but are not limited to one or more processors, such as a central processing unit (CPU) 510 and/or a graphics processing unit (GPU) 520; a data storage 550 component; one or more network hubs/connecting components (e.g., an ethernet network switch 540), engine control units (ECUs) 580, various navigation devices 560 and peripherals 570, intent communication components, and a power distribution system 590.

Hardware-based processors may be implemented within autonomous robots and other devices operating in accordance with various embodiments of the invention to execute program instructions and/or software, causing computers to perform various methods and/or tasks, including the techniques described herein. Several functions including but not limited to data processing, data collection, machine learning operations, and simulation generation can be implemented on singular processors, on multiple cores of singular computers, and/or distributed across multiple processors.

Processors may take various forms including but not limited to CPUs 510, digital signal processors (DSP), core processors within Application Specific Integrated Circuits (ASIC), and/or GPUs 520 for the manipulation of computer graphics and image processing. CPUs 510, including but not limited to ECUs 580 may be directed to (manual or automated) operations including (but not limited to) path planning, motion control safety, operation of turn signals, the performance of various intent communication techniques, power maintenance, and/or ongoing control of various hardware components. CPUs 510 may be coupled to at least one network interface hardware component including but not limited to network interface cards (NICs). Additionally or alternatively, network interfaces may take the form of one or more wireless interfaces and/or one or more wired interfaces. Network interfaces may be used to communicate with other devices and/or components as will be described further below. As indicated above, CPUs 510 may, additionally or alternatively, be coupled with one or more GPUs. GPUs may be directed towards, but are not limited to ongoing perception and sensory efforts, calibration, and remote operation (also referred to as “teleoperation” or “tele-ops”).

Processors implemented in accordance with numerous embodiments of the invention may be configured to process input data according to instructions stored in data storage 550 components. Data storage 550 components may include but are not limited to hard disk drives, nonvolatile memory, and/or other non-transient storage devices. Data storage 550 components, including but not limited to memory, can be loaded with software code that is executable by processors to achieve certain functions. Memory may exist in the form of tangible, non-transitory, computer-readable mediums configured to store instructions that are executable by the processor.

Data storage 550 components may be configured to include supplementary information and components including but not limited to navigation applications, model data, and sensor data. Navigation applications can be used to facilitate autonomous navigation utilizing mobility foundation processes implemented in accordance with many embodiments of the invention, including but not limited to those described above. Sensor data in accordance with a variety of embodiments of the invention can include various types of sensor data that can be used in evaluation processes. In certain embodiments, sensor data can include (but is not limited to) video, images, audio, etc. obtained from sensors (e.g., cameras) associated with given autonomous robots. In several embodiments, model data can store various parameters and/or weights for training and/or implementing various (e.g., mobility foundation) models that can be used for various processes as described in this specification. Model data in accordance with many embodiments of the invention can be updated through training on sensor data.

Systems configured in accordance with a number of embodiments may include various additional input-output (I/O) elements, including but not limited to parallel and/or serial ports, USB, Ethernet, and other ports and/or communication interfaces capable of connecting systems to external devices and components. The system illustrated in FIG. 5 includes an ethernet network switch used to connect multiple external devices on system networks. Ethernet network switches configured in accordance with several embodiments of the invention may connect devices including but not limited to, computing devices, Wi-Fi access points, Wi-Fi and Long-Term Evolution (LTE) antennae, and servers in Ethernet local area networks (LANs) to maintain ongoing communication. The system illustrated in FIG. 5 utilizes 40 Gigabit and 0.1 Gigabit Ethernet configurations, but systems arranged in accordance with numerous embodiments of the invention may implement any number of communication standards.

Systems configured in accordance with many embodiments of the invention may be powered utilizing a number of hardware components. Systems may be charged by, but are not limited to batteries and/or charging ports. Power may be distributed through systems utilizing mechanisms including but not limited to power distribution boxes. FIG. 5 discloses a distribution of power into the system in the form of simultaneous 12-volt and 48-volt circuits. Nevertheless, power distribution may utilize power arrangements including but not limited to parallel circuits, series circuits, multiple distributed circuits, and/or singular circuits. Additionally or alternatively, circuits may follow voltages including but not limited to those disclosed in FIG. 5. System driving mechanisms may obtain mobile power through arrangements including but not limited to centralized motors, motors connected to individual wheels, and/or motors connected to any subset of wheels. Further, while FIG. 5 discloses the use of a four-wheel system, systems configured in accordance with numerous embodiments of the invention may utilize any number and/or arrangement of wheels, legs, and/or propellors depending on the needs associated with a given system.

Autonomous vehicles configured in accordance with many embodiments of the invention can incorporate various navigation and motion-directed mechanisms including but not limited to engine control units 580. Engine control units 580 may monitor hardware including but not limited to steering, standard brakes, emergency brakes, and speed control mechanisms. Navigation by systems configured in accordance with numerous embodiments of the invention may be governed by navigation devices 560 including but not limited to inertial measurement units (IMUs), inertial navigation systems (INSs), global navigation satellite systems (GNSS), cameras, time of flight cameras, structured illumination, LiDARs, laser range finders and/or proximity sensors. IMUs may output specific forces, angular velocities, and/or orientations of the autonomous robots. INSs may output measurements from motion sensors and/or rotation sensors.

As mentioned above, autonomous robots may include one or more peripheral mechanisms (peripherals). Peripherals 570 may include any of a variety of components for capturing data, including but not limited to cameras, speakers, displays, and/or sensors. In a variety of embodiments, peripherals can be used to gather inputs and/or provide outputs. Autonomous robots can utilize network interfaces to transmit and receive data over networks based on the instructions performed by processors. Peripherals 570 and/or network interfaces in accordance with many embodiments of the invention can be used to gather inputs that can be used to localize and/or navigate ANSs. Sensors may include but are not limited to ultrasonic sensors, motion sensors, light sensors, infrared sensors, and/or custom sensors. Displays may include but are not limited to illuminators, LED lights, LCD lights, LED displays, and/or LCD displays. Intent communicators may be governed by a number of devices and/or components directed to informing third parties of autonomous navigation system motion, including but not limited to turn signals and/or speakers.

Autonomous robots configured in accordance with a number of embodiments, may utilize specialized sensors designed to provide specific relevant information including (but not limited to) images that contain depth information. Such specialized sensors may include but are not limited to structured light cameras, inertial measurement units (IMUs), laser range finders, proximity sensors, polarization cameras, stereo cameras, time of flight (ToF) cameras, three-dimensional (3D) sensors, ultrasonic sensors, and light detection and ranging (LiDAR) systems. Depth information, which is a term typically used to refer to information regarding the distance of a point and/or object, can be critically important in many (e.g., autonomous) navigation systems. In many embodiments, multiple sensors (e.g., cameras) may be incorporated to perform depth sensing by measuring parallax observable when measurements (e.g., images) of the same scene are captured from different viewpoints/perspectives. In certain embodiments, cameras that include (e.g., polarized) filters can be utilized that enable the capture of depth cues. As can readily be appreciated the specific sensors that are utilized depend upon the requirements of a given autonomous navigation system. The manner in which sensor data can be utilized by neural networks in accordance with certain embodiments of the invention is discussed below.

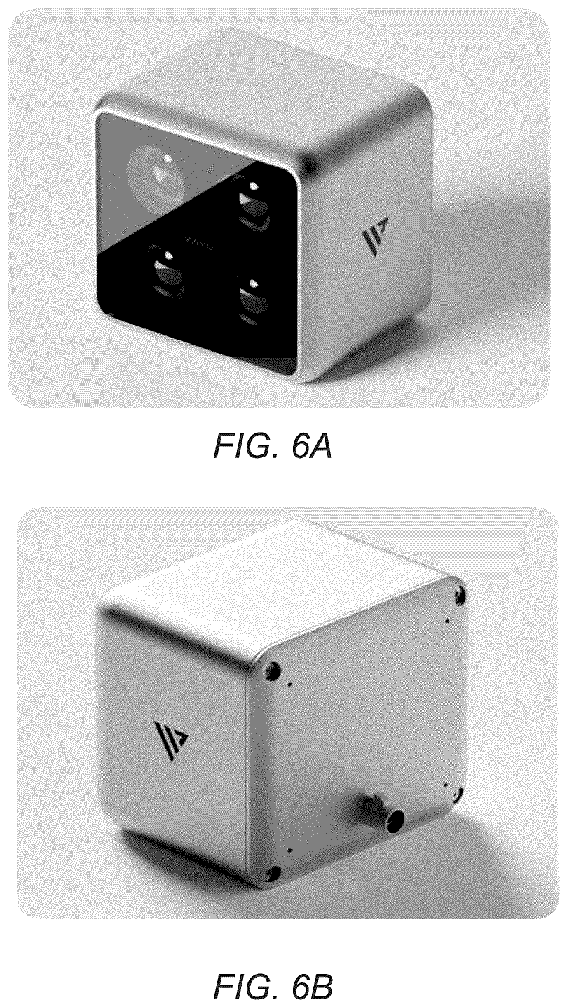

An example of a camera, operating in accordance with multiple embodiments of the invention, is illustrated in FIGS. 6A-6B. For systems implemented in accordance with many embodiments of the invention, the number of cameras used may vary by form factor. For example, wheeled automated robots may incorporate six image sensors, while some quadrupedal autonomous robots may use a single image sensor. As shown in FIG. 6A, cameras configured in accordance with many embodiments may incorporate four standard image sensors (e.g., in a 2×2 grid). Additionally or alternatively, each of the incorporated image sensors may have unique polarization filters applied at the corresponding apertures (enabling the capture of polarization depth cues). In several embodiments, these collections of multiple image sensors, configured with different polarization filters, can be utilized in multi-aperture arrays to capture images of a scene at different polarization angles. As mentioned above, autonomous robots may include any of a variety of sensory components for capturing and/or exhibiting data. In a variety of embodiments, the sensory components can be used to gather inputs and/or provide outputs, either of which can be used to localize and/or navigate robots. Additional sensors may include but are not limited to ultrasonic sensors, motion sensors, light sensors, infrared sensors, and/or custom sensors.

While not necessarily stated explicitly herein, the various features of each of the different autonomous robot implementations should be understood to be interchangeable and the illustration and/or discussion of particular combinations of features should not be regarded as limiting the possible configurations of autonomous robots implemented in accordance with various embodiments of the invention. Moreover, while specific autonomous navigation and sensor systems are described above with reference to FIGS. 3-6B, any of a variety of configurations can be implemented as appropriate to the requirements of specific applications in accordance with some embodiments of the invention. Furthermore, applications and methods in accordance with various embodiments of the invention are not limited to use within any specific autonomous robots. Accordingly, it should be appreciated that the implementations described herein can also be implemented outside the context of the autonomous robots (and components thereof) described above with reference to FIGS. 3-6B.

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for operating a mobile device, the method comprising:
receiving, at the mobile device:
an initial plurality of state tokens, wherein each of the initial plurality of state tokens corresponds to transformer model data reflecting at least one previous state of a mobile device; and
sensor data, from a set of one or more sensors that are appended to the mobile device;
determining at least one sub-task for the mobile device by inputting the initial plurality of state tokens into a particular large language model;
encoding the sensor data into a plurality of patch tokens, by inputting the sensor data into at least one vision transformer, wherein:
each of the plurality of patch tokens reflects at least one recent state of the mobile device; and
the at least one recent state corresponds to a period before the at least one previous state;
updating the initial plurality of state tokens into an updated plurality of state tokens by inputting the initial plurality of state tokens into at least one cross-attention transformer, wherein:
each of the updated plurality of state tokens corresponds to transformer model data reflecting the at least one recent state of the mobile device; and
the initial plurality of state tokens are updated based on the plurality of patch tokens and the at least one sub-task;
producing, by the mobile device, a set of navigation waypoints from the updated plurality of state tokens, wherein each of the set of navigation waypoints represents a distinct destination for the mobile device; and
controlling the mobile device according to the set of navigation waypoints.

2. The method of claim 1, wherein the mobile device is an autonomous vehicle.

3. The method of claim 1, wherein the set of one or more sensors includes at least one camera.

4. The method of claim 1, wherein encoding the sensor data into the plurality of patch tokens further comprises adding learned ray embeddings, produced using at least one Multi-Layer Perceptron (MLP), into each of the plurality of patch tokens.

5. The method of claim 1, wherein producing the set of navigation waypoints comprises producing, using a primary query decoder and the updated plurality of state tokens, at least one proposed path for the mobile device.

6. The method of claim 5, wherein the primary query decoder comprises at least one Diffusion Policy Decoder.

7. The method of claim 5, further comprising decoding a natural language query into a decoded query using a secondary query decoder, wherein the natural language query is received through a user interface.

8. The method of claim 7, further comprising projecting an answer to the decoded query on the user interface, wherein the answer to the decoded query is based on the updated plurality of state tokens and the sensor data.

9. The method of claim 7, wherein the secondary query decoder:
comprises an additional large language model; and
operates more slowly than the primary query decoder.

10. The method of claim 7, wherein the particular large language model, the at least one vision transformer, the at least one cross-attention transformer, the primary query decoder, and the secondary query decoder are components of a foundation model.

11. The method of claim 6, wherein the at least one proposed path is produced using a specific cross-attention transformer included in the primary query decoder, according to keys and values derived from the updated plurality of state tokens.

12. The method of claim 7, wherein:
the primary decoder operates on the mobile device; and
the secondary decoder operates on a remote server that is communicatively coupled to the mobile device.

13. The method of claim 5, wherein a given path of the at least one proposed path is selected from the group consisting of:
a planned spatial path comprising a set of spatially-separated points with consistent spacing;
a planned temporal path comprising a set of temporally-separated points with consistent spacing, derived according to a linear speed of the mobile device; and
a left boundary and a right boundary for the mobile device.

14. The method of claim 1, wherein the plurality of patch tokens comprises encodings of at least one of:
an estimate of a kinematic state of the mobile device, wherein the estimate comprises a linear speed of the mobile device and an angular speed of the mobile device;
a set of dimensions for the mobile device; or
a set of route instructions that are pre-determined for the mobile device.

15. The method of claim 1, wherein updating the initial plurality of state tokens comprises inputting the plurality of patch tokens and the at least one sub-task into a state aggregator.

16. The method of claim 15, wherein updating the initial plurality of state tokens further comprises:
producing a set of queries from the initial plurality of state tokens;
generating answers to the set of queries, using a cross-attention transformer included in the state aggregator, according to keys and values derived from the plurality of patch tokens and the at least one sub-task; and
applying the answers to updating the initial plurality of state tokens.

17. The method of claim 16, wherein updating the initial plurality of state tokens further comprises inputting the updated plurality of state tokens into at least one of a feed-forward network or a self-attention network.

18. The method of claim 17, wherein the at least one of the feed-forward network or the self-attention network is incorporated into the state aggregator.

19. The method of claim 1, wherein a quantity of the initial plurality of state tokens remains constant when updated into the updated plurality of state tokens.

20. A method for operating a mobile device, the method comprising:
receiving, at the mobile device:
an initial plurality of state tokens, wherein each of the initial plurality of state tokens corresponds to transformer model data reflecting at least one previous state of a mobile device; and
sensor data, from a set of one or more sensors that are appended to the mobile device;
determining at least one sub-task for the mobile device by inputting the initial plurality of state tokens into a particular large language model;
encoding the sensor data into a plurality of patch tokens, by inputting the sensor data into at least one vision transformer, wherein:
each of the plurality of patch tokens reflects at least one recent state of the mobile device; and
the at least one recent state corresponds to a period before the at least one previous state;
updating the initial plurality of state tokens into an updated plurality of state tokens by inputting the initial plurality of state tokens into at least one cross-attention transformer, wherein:
each of the updated plurality of state tokens corresponds to transformer model data reflecting the at least one recent state of the mobile device;
a quantity of the initial plurality of state tokens remains constant when updated into the updated plurality of state tokens; and
the initial plurality of state tokens are updated based on the plurality of patch tokens and the at least one sub-task;
producing, by the mobile device, a set of navigation waypoints from the updated plurality of state tokens, wherein:
producing the set of navigation waypoints comprises producing at least one proposed path for the mobile device, wherein the at least one proposed path is produced using a specific cross-attention transformer included in a primary query decoder, according to keys and values derived from the updated plurality of state tokens; and
each of the set of navigation waypoints represents a distinct destination for the mobile device;
controlling the mobile device according to the set of navigation waypoints; and
when a natural language query, corresponding to the mobile device, is received through a user interface of the mobile device:
decoding the natural language query into a decoded query using a secondary query decoder, wherein:
the secondary query decoder:
comprises an additional large language model; and
operates more slowly than the primary query decoder; and
the particular large language model, the at least one vision transformer, the at least one cross-attention transformer, the primary query decoder, and the secondary query decoder are components of a foundation model; and
projecting an answer to the decoded query on the user interface, wherein the answer to the decoded query is based on the updated plurality of state tokens and the sensor data.
